(19) United States
(12) Patent Application Publication
(10) Pub. No.: US 2013/0133570 A1
(43) Pub. Date: May 30, 2013

(54) VACUUM DEPOSITION DEVICE

(71) Applicants: TENG-TSUNG HUANG, Tu-Cheng (TW); HUA-YONG XU, Shenzhen City (CN); ZHEN-ZHANG LIU, Shenzhen City (CN)

(72) Inventors: TENG-TSUNG HUANG, Tu-Cheng (TW); HUA-YONG XU, Shenzhen City (CN); ZHEN-ZHANG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/441,989

(22) Filed: Apr. 9, 2012

(30) Foreign Application Priority Data
Nov. 28, 2011 (CN) 201110383673.6

(51) Int. Cl. B05C 9/00; B05C 11/00

(52) U.S. Cl. 118/50

(57) ABSTRACT

A vacuum deposition device includes a coating chamber. The coating chamber defines a top wall and a bottom wall. A cooling device is defined in the top or bottom wall. The cooling device includes a cooling runner formed in the top or bottom wall defining the cooling device.

### BACKGROUND

1. Technical Field

The present disclosure relates to a vacuum deposition device. p 2. Description of Related Art

A physical vapor deposition process is carried out in a coating chamber of a vacuum deposition device to form a film on the target object (such as a substrate). Most of the processes are implemented at a temperature of about 200° C.-300° C. for enhancing the bond between the film and the substrate. Thus, the body of the coating chamber of the vacuum deposition device is always under a high temperature. It is necessary to cool the high temperature body of the coating chamber to protect the device from damage. Cooling the vacuum deposition device typically involves cooling plates having cooling runners formed therein formed on the outside wall of the coating chamber. However, this cooling method has a poor effect. To improve the cooling effect, a lower temperature of cooling water (about 9° C.) may be used. However, the use of lower temperature cooling water is prone to forming condensed water on the body of the coating chamber. The condensed water has the disadvantages of rusting the body, and electrically connecting the body and targets used for depositing the film, which interferes with the deposition.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of a vacuum deposition device.

FIG. 2 is a schematic view of a cooling device defined in the vacuum deposition device shown in FIG. 1.

### DETAILED DESCRIPTION

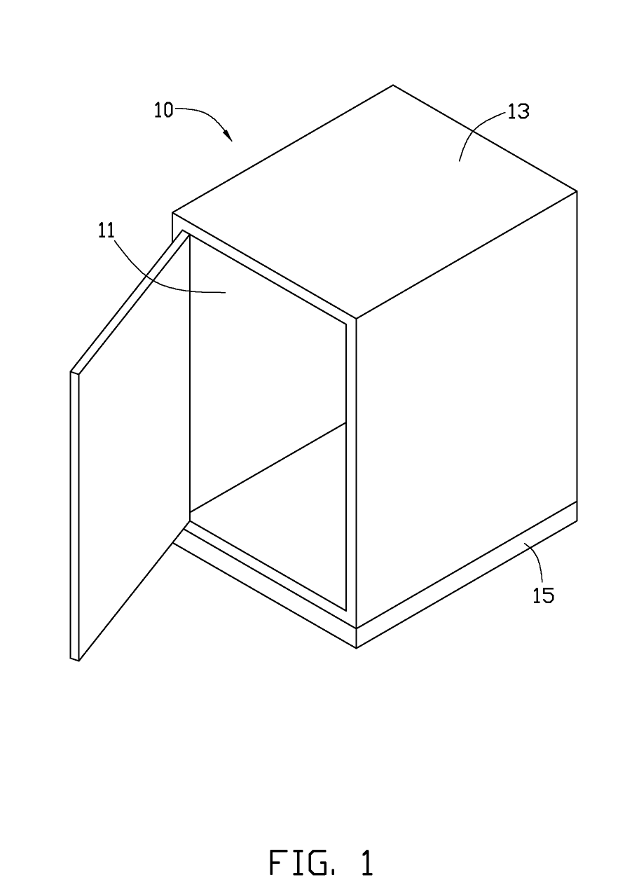

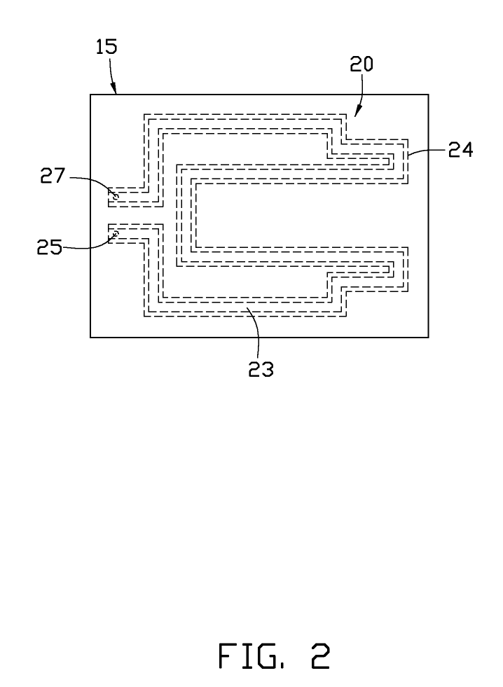

Referring to FIGS. 1 and 2, in an embodiment, a vacuum deposition device 10 includes a top wall 13, a bottom wall 15, a coating chamber 11, and a cooling device 20 defined in the bottom wall 15.

The cooling device 20 includes a cooling runner 23, an entrance of cooling agent 25 and an outlet of cooling agent 27 that all connecting with the cooling runner 23. The cooling runner 23 may have a depth of about 10 mm to about 15 mm. The cooling runner 23 can be formed by laser grooving the bottom wall 15, or lathing the bottom wall 15. A steel plate 24 is welded to the bottom wall 15 and on the cooling runner 23 to seal the cooling runner 23, so the cooling agent, such as cooling water, can flow through the cooling runner 23 to cool the vacuum deposition device 10. The steel plate 24 may have a thickness of about 2 mm to about 5 mm.

The cooling runner 23 can be defined as a curved pattern to increase the length of the cooling runner 23 and improving the cooling effect.

It is to be understood that, the cooling device 20 can also be defined in the top wall 13.

The cooling runner 23 of the cooling device 20 in the embodiment is directly formed in the top wall 13 or the bottom wall 15, so the cooling water flowing through the cooling runner 23 can better cool the top or bottom wall of the vacuum deposition device 10. As such, the temperature of the cooling water can be increased to about 14° C.-19° C., thereby preventing condensed water from forming on the top or bottom wall of the vacuum deposition device 10.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A vacuum deposition device, comprising:
a coating chamber having a top wall and a bottom wall; and
a cooling device defined in the top or bottom wall, the cooling device comprising a cooling runner formed in the wall defining the cooling device.

2. The vacuum deposition device as claimed in claim 1, wherein the cooling runner has a depth of about 10 mm-15 mm.

3. The vacuum deposition device as claimed in claim 1, wherein the cooling runner is sealed by a steel plate which is welded to the wall defining the cooling runner to confine liquid to the cooling runner.

4. The vacuum deposition device as claimed in claim 3, wherein the steel plate has a thickness of about 2 mm-5 mm.

5. The vacuum deposition device as claimed in claim 1, wherein the cooling runner is formed by laser grooving or lathing the wall defining the cooling runner.

6. The vacuum deposition device as claimed in claim 1, wherein the cooling device comprising an entrance of cooling agent and an outlet of cooling agent connecting with the cooling runner

7. The vacuum deposition device as claimed in claim 1, wherein the cooling runner, defined to have a curved pattern, is defined in the top or bottom wall.
